(19) United States
(12) Patent Application Publication
(10) Pub. No.: US 2012/0317713 A1
(43) Pub. Date: Dec. 20, 2012

(54) Device to help nurse and move immobile patients in bed

(76) Inventors: Osnat Eytan, Rosh Ha-Ayin (IL); Eyal Leibovitz, Ramat-Gan (IL)

(21) Appl. No.: 13/209,419

(22) Filed: Aug. 14, 2011

Related U.S. Application Data
(60) Provisional application No. 61/401,461, filed on Aug. 16, 2010.

(51) Int. Cl. A61G 7/10

(52) U.S. Cl. 5/81.1 R

(57) ABSTRACT

An apparatus for nursing immobile patients in bed includes a base, a sheet and a control unit. Both the base and sheet components include magnetic elements. The sheet is placed on top of the base, and the patient is lying on top of the sheet. When activated, the magnetic elements in the sheet and base repel each other. The resultant magnetic force opposes the weight of a patient by that, elevate the patient. Under these conditions, the net force (Normal force) is reduced, leading to reduced friction force between the base and sheet components. Moreover, the magnetic elements produce a force perpendicular to the static magnetic field which creates a torque that may contribute to the rotation of the sheet component. This in turn leads to a reduction in the workload needed to change a patient's position.

### BACKGROUND OF THE INVENTION

A. Field of the Invention

The present invention relates generally to magnetic repulsion. More particularly, the present invention relates to an adaptive magnetic repulsion apparatus and method includes base and flexible (or rigid) platform arrays of computer-controlled electromagnets, permanent magnets or combination, for providing controlled low friction or frictionless rotational movement of a platform in two or three dimensions. The invention utilizes (i) the magnetic force to reduce friction and (ii) the torque resulted from the magnetic interactions (repulsion) to ease on the turning motion.

B. Background

With the advancement of modern medicine, there is a significant increase in the prevalence of conditions that lead to patient immobility. Regardless of the reason for this condition, the actual immobility is associated with patients' increased morbidity and mortality. The tending staff, namely the nurses, have to actively move the patient in bed to prevent the occurrence of immobility-associated complications such as pressure sores, and to maintain hygiene. The increase in the prevalence of this condition, alongside the obesity epidemic that results in a heavier patient, increases the risk for back trauma among the nursing staff as well as any other tending persons.

The current invention utilizes magnetic repulsion to reduce the friction force between two planes. It is inspired by magnetic levitation which is known to produce frictionless motion. The invention is similar to a magnetic levitation system by the fact that it is composed of two facing planes in which the arrangement of magnets on one plane supports a levitated magnetic element of an opposite plane. The magnetic arrangement provides a static magnetic field between the planes but it also provides a variable force in a direction perpendicular to that field. However, magnetic levitation systems include magnetic components to control and stabilize the variable force while the invention enclosed here, utilizes the resulted torque to assist the rotation of the upper plane.

### SUMMARY OF THE INVENTION

One of the basic missions of nurses is to mobilize immobile patient in bed. This is done to prevent the occurrence of immobility-associated complications and to maintain hygiene. The flaccid body of the patient, along with the increased average weight of patients (as a result of the obesity epidemic) led to a massive increase in the physical workload when performing this task. The later increases the risk for back trauma among the nursing staff.

We hereby introduce an innovative device that helps nurses mobilize patients in their bed by tackling the patient's heavy weight. It is made out of two parts with magnetic elements imbedded in them. The lower part is termed “base” and the top part is termed “sheet”, while the patient is lying on top of the top part. When activated, the magnetic elements in the sheet and base repel each other, and the resultant magnetic force opposes the weight of the patient. Under these conditions, the “effective weight” of the patient (called the normal force) is reduced, and the person “feels” lighter to all who nurse him. The magnetic force counteracts the effect of the patient's weight, and by that reduces the friction force between the base and sheet parts. In addition, the force that results from the static magnetic field produces a torque that contributes to the rotation of the patient in bed. This in turn leads to a reduction in the workload needed to perform this task.

### BRIEF DESCRIPTION OF THE DRAWINGS

FIG. 1: The device when used on a patient: at rest, before activation and after turning the patient on his side.

FIG. 2: The device is illustrated. The sheet has magnetic and non magnetic zones and composed of longitudinal bands.

FIG. 3: The layers of one longitudinal band of the sheet.

FIG. 4: The inner magnetic layer of one longitudinal band illustrating an example of magnetic and non-magnetic zones.

FIG. 5: The layers of the base.

FIG. 6: The base is imbedded in a designated mattress.

FIG. 7: The base part as a box when put underneath the mattress and attached to a bed frame.

FIG. 8: The main electrical components of the device are controlled and monitored respectively via the optional debug terminal.

FIG. 9: The block diagram illustrates a typical system for controlling the current that is driving the coils in the base and sheet of the device.

FIG. 10: Plot of current driven into the coils during the charging and discharging.

FIG. 11: The movements of the sheet part on top of the base part before and after 90° turn.

### DETAILED DESCRIPTION OF THE PREFERRED EMBODIMENTS

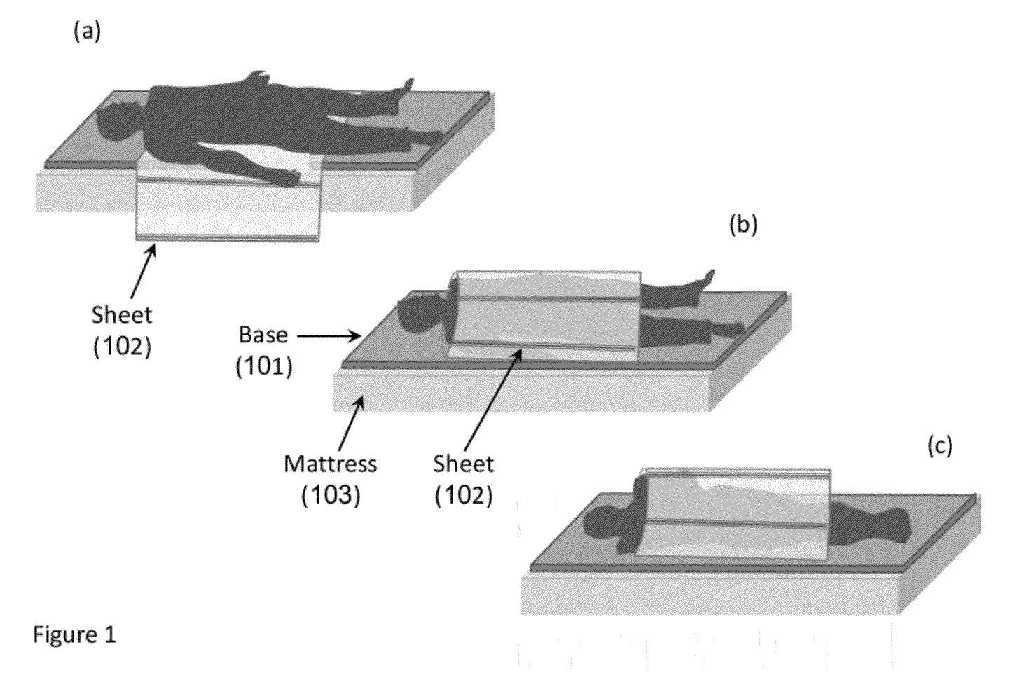

The present invention allows turning immobile patient in bed. As illustrated in FIG. 1, the device is composed of two magnetic parts: a base (101) and a sheet (102). At rest, the patient is lying on the device (panel a). Before activation, the sheet part (102) is used to wrap the patient (panel b) Following the repositioning, when the patient is in the required position (panel c), the sheet is loosened.

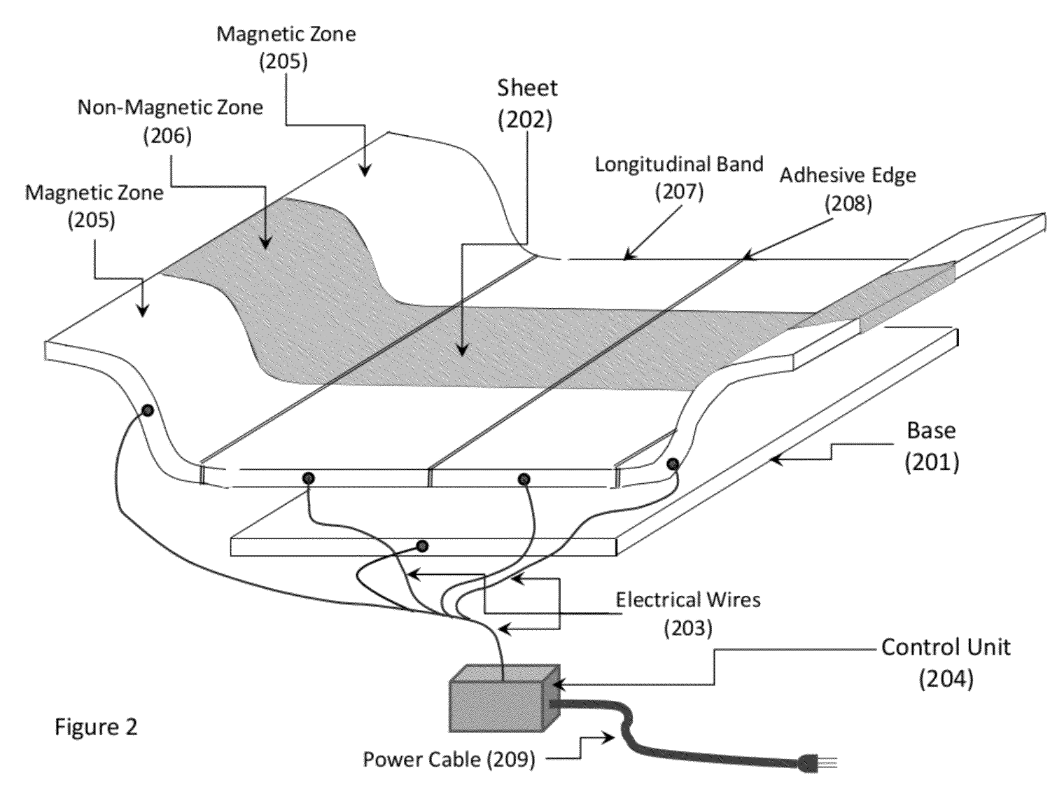

The device is illustrated in FIG. 2. The device has two overlapping parts—the base (201) and the covering sheet (202). The device is connected by electrical wires (203) to a control unit (204). As mentioned above, both the base part and the sheet part are magnetic, and may contain permanent magnets, electro-magnets or a combination of both. The magnets are placed in strategic places (205) within the base and sheet parts (not shown in base part). These strategic places are determined according to a pre-specified design that (1) takes into account the number of magnets needed to partially or fully lift the patient; (2) creates fairly stable and uniform magnetic field that covers the area underneath the patient; (3) considers the power of the magnetic field of each magnet; (4) allows weight distribution of a normal human body along the sheet part; and (5) includes additional parameters such as technological, electrical and mechanical constrains, human engineering etc.

A non-magnetic zone or zones (206) may also be available (not illustrated in the base part). These non magnetic zones may be comprised of non magnetic material, or could be gaps (no material) between the magnetic zones. The activation, mode of function, and deactivation of the magnets are controlled by a control unit, according to pre-specified programming. When the device is switched “On” (at the control unit), the electro-magnets are becoming active. The placement of the magnets is specific to create a force of repulsion between the sheet and the base. The sheet may be made of several individual longitudinal bands (207), connected together with a means of adhesion (208). All bands may be similar in size or vary in dimensions depending on their position when covering the patient (either back, front or sides). The number of such bands depends on several parameters such as the size of the bed, the weight of the patient and the angle of turn required for the certain patient.

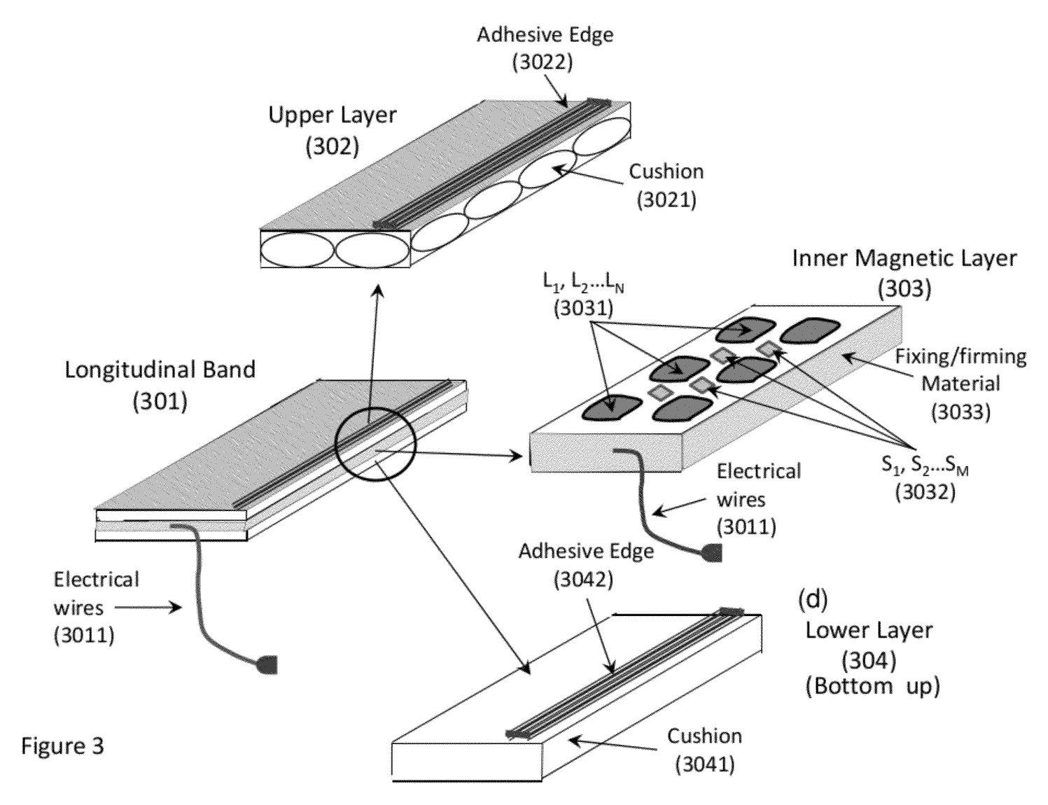

FIG. 3 illustrates one longitudinal band (301) of the sheet. Each longitudinal band is made of several layers (i.e., 302-304). Top layer (302) is a cushion for comfort, and may contain air cells, foam, latex and/or any other means of cushioning (3021). An adhesive edge is available on top of the layer (3022), and is used to attach the part to other similar parts. The inner layer (303) contains the magnets (either permanent or electromagnets, or a combination of both, marked as L₁, L₂ . . . L_{N}, 3031), and sensors (pressure, heat or any other type, marked S₁, S₂ . . . Sₘ, 3032). The magnets and sensors are connected via electrical wires to the control unit (not shown in figure). The layer is made of an insulating material that fixes the instruments and prevents magnetic effects of neighbouring magnets (3033). The bottom layer of the sheet (304) serves as a fixative layer for the (inner) magnetic layer (3041). It also contains an additional adhesive edge (3042) to facilitate the combination of several such bands, and is attached to the adhesive edge on the top layer of another band. This layer may also contain additional cushioning materials (such as foam, latex or any other, alone or in combination, not elaborated in figure).

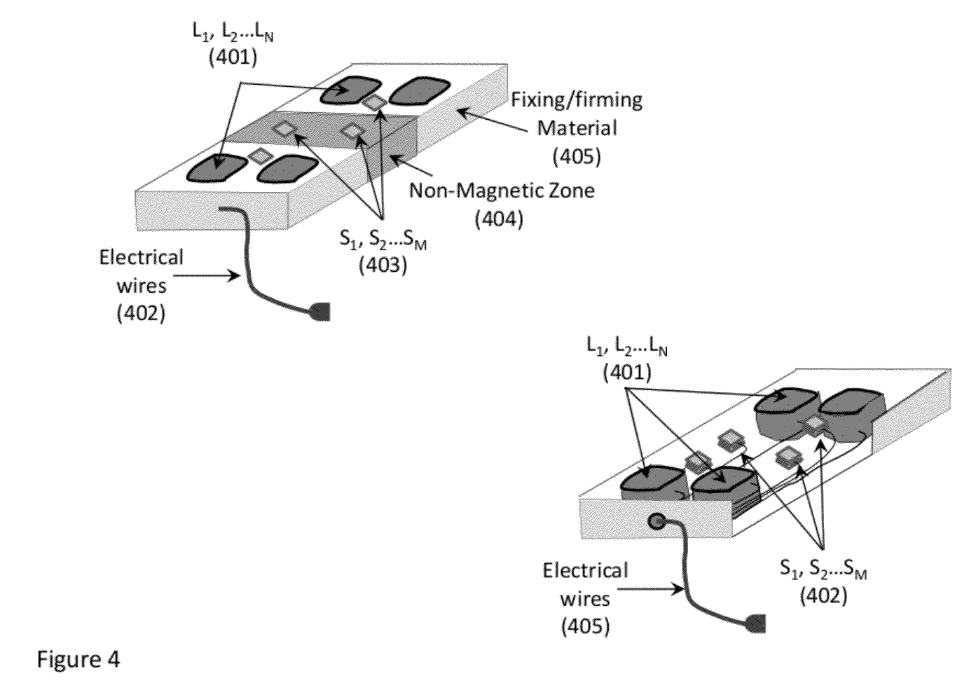

The inner magnetic layer of one longitudinal band of the sheet is illustrated in FIG. 4. The inner magnetic layer contains the permanent magnets and/or coils of the electro-magnets (flat and/or solenoid), marked 401. The electro-magnets are connected to their designated drivers in the control unit (not shown in figure) by electrical wires (402). The inner magnetic layer also contains sensors (of pressure, temperature and other, 403) that are connected to the control unit by electrical wires (402). When activated, the control unit provides signals to the magnets, to facilitates the desired profiles (the magnetic field generated by the magnets), according to digital and analogue signals inputted from the sensors, executed programs stored in the memory block of the control unit (not shown in figure), switches on the control panel (not shown in figure) and commands entered through the communication port.

The non-magnetic zones (404), which may vary in size and location, are areas within the band where there are few or no magnets at all. The arrangement of the magnets in the band is designed to optimize the magnetic field while minimizing the size of the device. The whole section in embedded in a fixing material to prevent the movements of the parts (305). The magnetic zones may differ between bands of the same sheet.

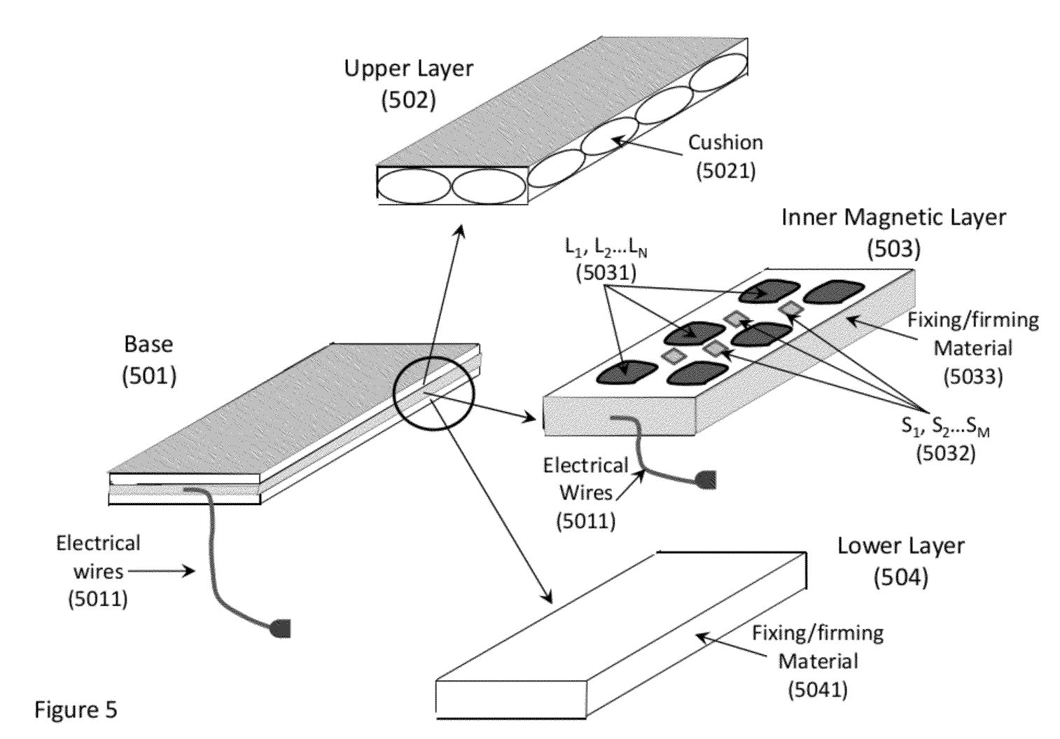

The base part may be in three different configurations: base on mattress, base embedded in mattress, base below mattress or bed frame. FIG. 5 illustrates the base part (501), when put on top of a mattress. The base part is made of several layers. Top layer (502) is a cushion for comfort, and may contain air cells, foam, latex and/or any other means of cushioning (5021). The inner magnetic layer (503) contains magnets (either permanent or electromagnets, or a combination of both, marked as L₁, L₂ . . . L_{N}, 5031), and sensors (pressure, heat or any other type, marked S₁, S₂ . . . S_{M}, 5032). The magnets and sensors are connected via electrical wires (5011) to the control unit (not shown in figure). Both magnets and sensors are imbedded in an insulating material (4033). The bottom layer of the sheet (504) serves as a fixative and supportive layer for the magnets in the inner layer (5041).

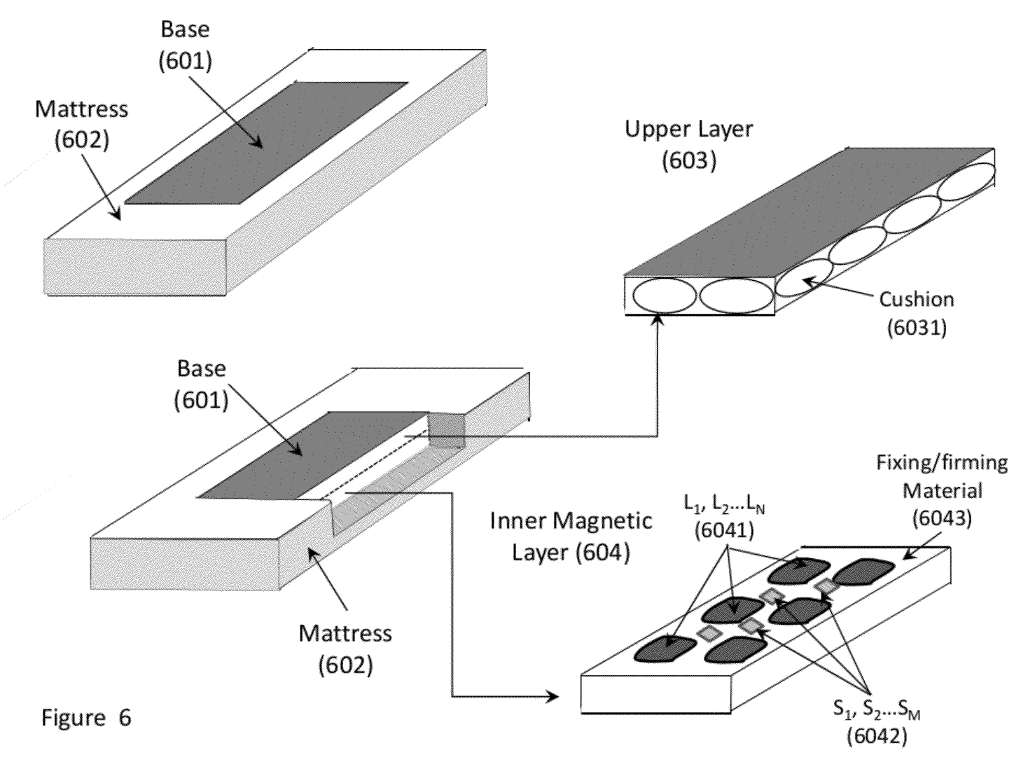

FIG. 6 illustrates the base part (601), when imbedded in a designated mattress (602). The base part is made of several layers (i.e. 603, 604). Top layer (603) is a cushion for comfort, and may contain air cells, foam, latex and/or any other means of cushioning (6031). The inner magnetic layer (604) is made of magnets (either permanent or electromagnets, or a combination of both, marked as L₁, L₂ . . . L_{N}, 6041), and sensors (pressure, heat or any other type, marked S₁, S₂ . . . S_{M}, 6042). In this configuration, the mattress serves as the support layer. The magnets and sensors are connected via wires to the control unit (both not shown in figure). Both magnets and sensors are imbedded in an insulating/fixing material (6043).

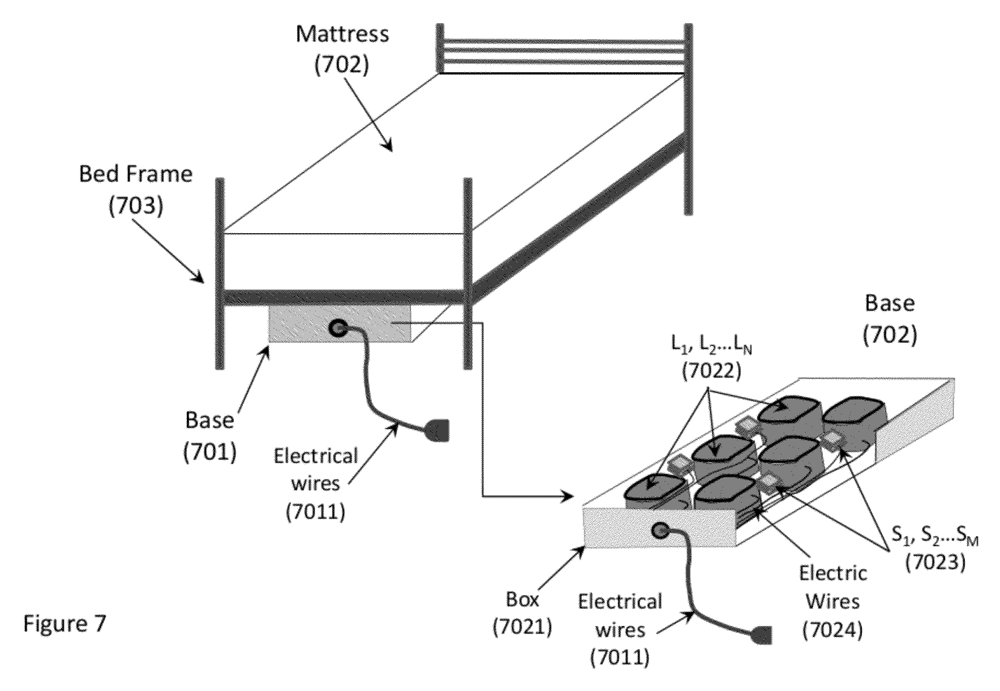

In FIG. 7 the base part (701) is shown when put underneath the mattress (702) and bed frame (703). The base part is made of a box (7021), which contains either permanent or electromagnets, or a combination of both, (marked as L₁, L₂ . . . L_{N}, 7022), and sensors (pressure, heat or any other type, marked S₁, S₂ . . . S_{M}, 7023). The magnets and sensors are connected via electrical wires (7024, 7011) to the control unit (not shown in figure). Both magnets and sensors are imbedded in insulating/fixing material (not shown).

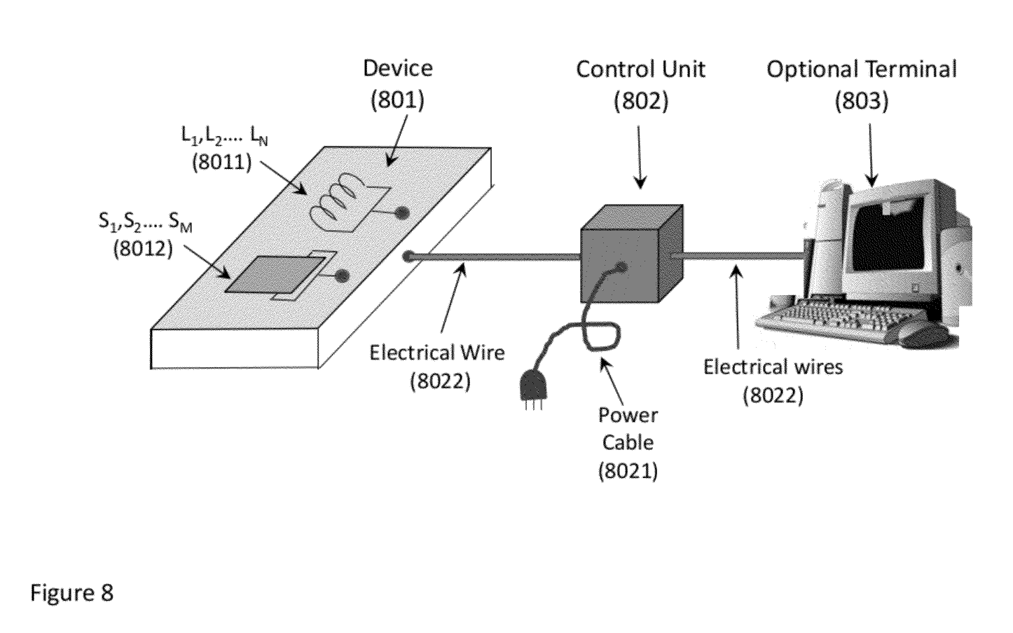

The main electrical components of the device are illustrated in FIG. 8. Coils L₁ through L_{M} (8011) and sensors S₁ through S_{M} (8012) are embedded in the base and sheet parts (only one shown in figure) of the device (801). The control unit (802) provides the signals to the coils and receives signals from the sensors, which are controlled and monitored respectively via the optional debug terminal (803).

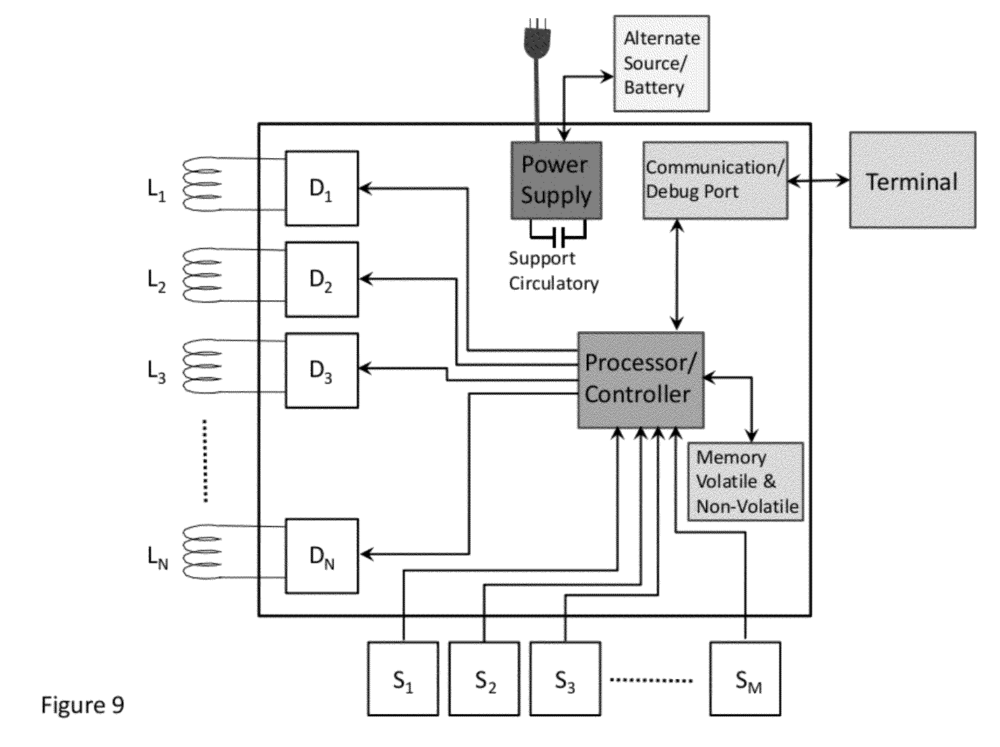

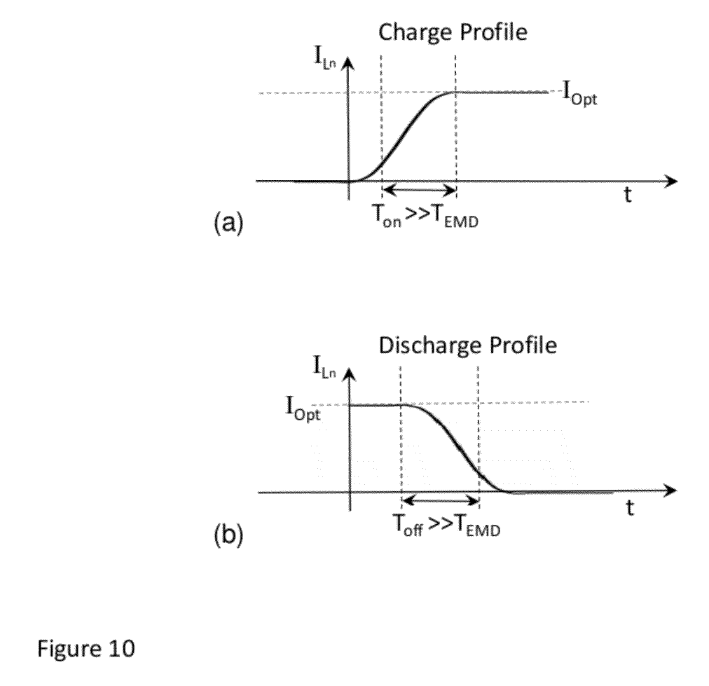

The block diagram in FIG. 9 illustrates a typical system for controlling the current that is driving to the coils in the base and sheet of the device. L₁ through L_{N} represent the required number of coils that are needed to either lift the patient and/or reduce the friction force. The number “N” depends on the size of the electromagnets, the size of the sheet as well as other factors. D₁ through D_{N} represent the current drivers, which drive current into the coils, according to the predetermined current charge and discharge profiles (FIG. 10). S₁ through S_{M} represent the number of sensors that are required for proper operation of the device. The type of sensors varies and includes sensors of heat, pressure, current, magnetic field, etc.

The processor provides analogue and digital signals to the drivers, to facilitates the desired profiles, according to digital and analogue signals inputted from the sensors, executed programs stored in the memory block, switches on the control panel (not shown in figure) and commands entered through the communication port (if any). In addition, the communication port allows bi-directional flow of data, and commands between the terminal and the processor. Once the debug process and the development cycle are complete, the terminal is optional and all commands are entered through the control panel.

The system accepts and alternate source of power such as a battery, for the purpose of maintaining the desired current profile during a power failure, and maintaining general operation during power failure. The components are shown as separate blocks, but the electric circuit could be implemented in fewer or in a single integrated circuit such as ASIC.

FIG. 10 shows the current profile driven into the coils during the charging (Panel A) and discharging (Panel B). The process is fully controlled according to the desired profiles. For example, the rise time, Tₒₙ, and the fall time, T_{off}, of the current are designed to be above a pre-determined value, in order to reduce the frequency of the electromagnetic disturbance (EMD) radiated from the coils. This is to ensure minimal electromagnetic effect of the device on additional electrical devices in a hospital/medical facility setting. An additional example is the need to control the strength of the magnetic field, according to input from the users, via the switches on the control panel (not shown).

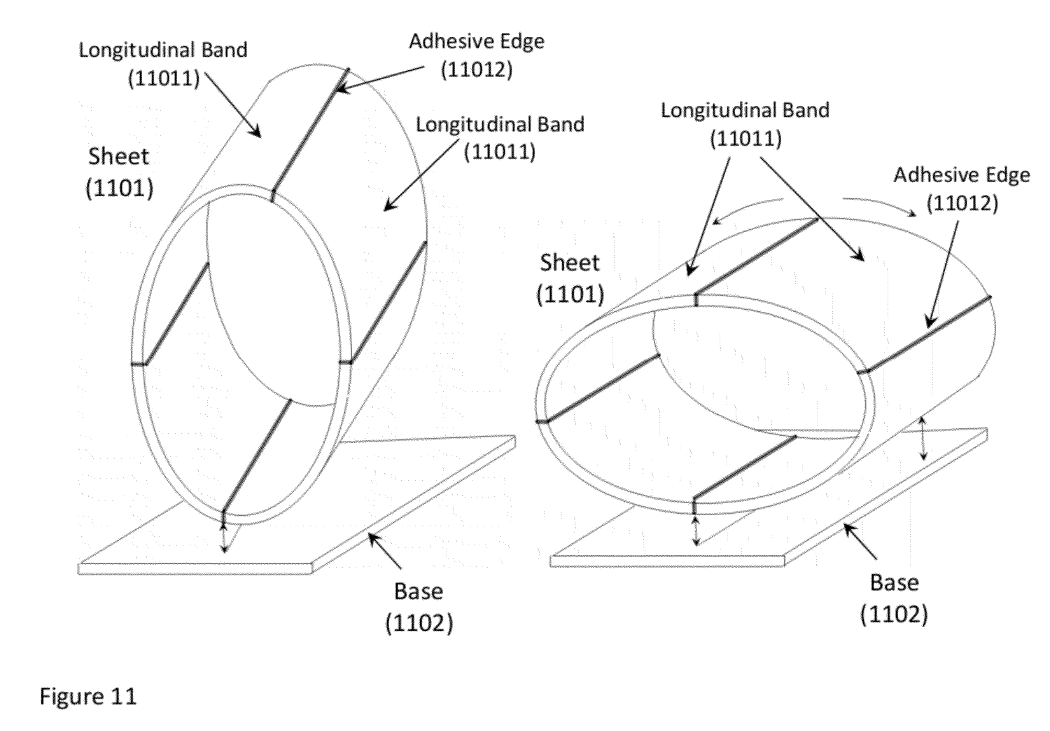

In order to turn a patient (FIG. 11) the sheet part (1101) has to move on top of the base part (1102). The flexible sheet part may be used to wrap a patient. When given the order from the control unit (not shown in figure) via the wires (not shown in figure) the magnets in the base and sheet parts (not shown in figure) repels each other, and this causes the sheet part to partially levitate on top of the base part. The elevation of the sheet above the base enables the sheet to be moved on top of the base part with minimal friction, and may even be turned on the side. The sheet part may be made of individual magnetic longitudinal bands (11011) connected together with Velcro or other means of adhesion (11012). The size of the sheet parts may vary, depending on the size of the patient and/or the bed, to enable the unwrapping of the sheet part symmetrically, regardless of its relative position on the base part, even after turned 90 degrees (left panel).

We claim:

1. An apparatus for nursing immobilized patients in their bed, the apparatus comprising:
A bottom base part, the base part is embedded within one of at least a bed frame, a platform, or a mattress; and
A top sheet part, the sheet part comprises a plurality of bands,
Both base and sheet parts comprise of at least one of a plurality of electro magnets or a plurality of permanent magnets.

2. The apparatus of claim 1, wherein the magnets are distributed within the base part and sheet part and are configured, upon activation, to repeal the sheet part from the base part, thereby reducing friction force affecting the sheet part (the friction force caused by a patient weight pressing on the sheet part).

3. The apparatus of claim 2, wherein the magnets in the sheet part are distributed to form one or more horizontal alternating magnetic and non-magnetic zones, said non-magnetic zones comprising non magnetic components or magnets.

4. The apparatus of claim 3, wherein the plurality of bands are vertical bands, forming a mesh with the horizontal magnetic and non-magnetic zones, and wherein the bands and zones have at least one of similar widths, varying widths, uniform magnet distribution patterns, or varying magnetic distribution patterns.

5. The apparatus of claim 4, wherein each vertical bands comprises a first top layer, a first inner layer, and a first bottom fixative layer, wherein a patient lies above the top layer, and wherein the magnets are embedded within the inner layer.

6. The apparatus of claim 5, wherein the top layer functions as a cushion for patient comfort and comprises at least one of air cells, foam, latex, or a cushioning material.

7. The apparatus of claim 5, wherein the inner layer further comprises additional components of at least one of a pressure sensor, heat sensor, and insulating material that fixes components within the inner layer and prevents adverse magnetic and physical effects of neighboring components.

8. The apparatus of claim 5, wherein the bottom functions a fixative layer for the inner layer and as a bottom cover for the sheet part, wherein the bottom layer further comprises additional components of at least one of a pressure sensors, at least one of air cells, foam, latex, or a cushioning material.

9. The apparatus of claim 5, wherein adhesive edges attach the vertical bands.

10. The apparatus of claim 1, wherein the base part is placed on top of a mattress, within a mattress, beneath a mattress, or constitute a mattress of a bed frame.

11. The apparatus of claim 5, wherein the base part comprises similar layers and components as the sheet part.

12. The apparatus of claim 11 further comprising a main control unit part, and wherein magnets and sensors within the base and sheet parts are connected by electrical wires to said main control unit.

13. The apparatus of claim 2, wherein the activation of the magnets is controlled by the main control unit, the main control unit comprising of a processor and software program executed thereon, and wherein the activation is performed according to an “ON” software instruction written in a programming language executed by said processor.

14. The apparatus of claim 7 or 11 further comprising a main control unit part, and wherein the sensors transmit electrical signals carrying information over electrical wires to the main control unit.

15. The apparatus of claim 11 further comprising a main control unit part, and wherein a processor within the main control unit provides analogue and digital signals to drivers of the magnets and sensors, to facilitate a desired magnetic field, generated by the magnets, according to signals inputted from the sensors.

16. The apparatus of claim 11 further comprising a main control unit part, and wherein a processor within the main control unit executes a software program stored on a storage medium, and wherein the program executes in response to at least one of activated switches on a control panel and commands entered via a communication port.

17. The apparatus of claim 13, wherein the apparatus is coupled to at least one of a main power source or a battery.
